(19) United States
(12) Patent Application Publication
(10) Pub. No.: US 2015/0170038 A1
(43) Pub. Date: Jun. 18, 2015

(54) Method And System For Generating Item Recommendation

(71) Applicant: Industrial Technology Research Institute, Hsinchu (TW)

(72) Inventors: Kuang-Hung Cheng, Tainan City (TW); Shun-Chieh Lin, Tainan City (TW); Huan-Wen Tsai, Hsinchu City (TW); Chien-Kuo Lin, Kaohsiung City (TW)

(73) Assignee: Industrial Technology Research Institute

(21) Appl. No.: 14/109,383

(22) Filed: Dec. 17, 2013

(51) Int. Cl. G06N 5/04

(52) U.S. Cl. CPC G06N 5/04

(57) ABSTRACT

A method for a system to generate an item recommendation. The method includes determining, for each of a plurality of roles, a plurality of reference utility values each for one of a plurality of items, and performing a normalization on the plurality of reference utility values determined for each of the plurality of roles. The method further includes determining a plurality of aggregate utility values each for one of the plurality of items, based on a plurality of normalized reference utility values determined for each of the plurality of roles, and determining one or more combinations of items for recommendation based on the plurality of aggregate utility values.

### TECHNICAL FIELD

This disclosure relates to a method and system for generating an item recommendation.

### BACKGROUND

With the development of electronic commerce, the buying and selling of products can be conducted over electronic systems on the Internet and computer networks. For example, an online retailer provides a website as a platform for product suppliers, such as manufacturers, to sell products to consumers. Generally, the product suppliers manage theft products for selling on the website, the consumers review and make any purchase of products from the website, and the online retailer performs maintenance on the website.

When there are a large number of products available from the online retailer, it may be difficult for a consumer to find on the website products that the consumer wants to purchase. To facilitate the consumer's purchase of products from the website, the online retailer generally uses a product recommendation system to generate a recommendation of one or more products for the consumer's consideration.

A conventional product recommendation system generally generates a product recommendation based on utility for only one role in a business transaction. For example, the conventional product recommendation system may generate a product recommendation based only on improving consumer purchase experience, such that the generated item recommendation has a high hitting rate. Also for example, the conventional product recommendation system may generate a product recommendation based only on maximizing a supplier's profit.

### SUMMARY

According to the present disclosure, there is provided a method for a system to generate an item recommendation, comprising: determining, for each of a plurality of roles, a plurality of reference utility values each for one of a plurality of items; performing a normalization on the plurality of reference utility values determined for each of the plurality of roles; determining a plurality of aggregate utility values each for one of the plurality of items, based on a plurality of normalized reference utility values determined for each of the plurality of roles; and determining one or more combinations of items for recommendation based on the plurality of aggregate utility values.

According to the present disclosure, there is provided a system for generating an item recommendation, comprising: a processor; and a memory for storing instructions executable by the processor, wherein the processor is configured to: determine, for each of a plurality of roles, a plurality of reference utility values each for one of a plurality of items; perform a normalization on the plurality of reference utility values determined for each of the plurality of roles; determine a plurality of aggregate utility values each for one of the plurality of items, based on a plurality of normalized reference utility values determined for each of the plurality of roles; and determine one or more combinations of items for recommendation based on the plurality of aggregate utility values.

According to the present disclosure, there is provided a non-transitory medium including instructions, executable by a processor, for performing an item recommendation method, the method comprising: determining, for each of a plurality of roles, a plurality of reference utility values each for one of a plurality of items; performing a normalization on the plurality of reference utility values determined for each of the plurality of roles; determining a plurality of aggregate utility values each for one of the plurality of items, based on a plurality of normalized reference utility values determined for each of the plurality of roles; and determining one or more combinations of items for recommendation based on the plurality of aggregate utility values.

According to the present disclosure, there is provided a system to generate an item recommendation, comprising; a database configured to store a plurality of utility models and consumer information; a utility model management module configured to determine, for each of a plurality of roles, a plurality of reference utility values each for one of a plurality of items, based on the plurality of utility models; a utility aggregating module configured to perform a normalization on the plurality of reference utility values determined for each of the plurality of roles, and to determine a plurality of aggregate utility values each for one of the plurality of items, based on a plurality of normalized reference utility values determined for each of the plurality of roles; and a high utility pattern mining module configured to determine one or more combinations of items for recommendation based on the plurality of aggregate utility values.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flowchart of a method for a system to provide an item recommendation, according to an exemplary embodiment.

FIG. 2 shows a two-phase high utility pattern mining algorithm, according to an exemplary embodiment.

FIG. 3 is a flowchart of a method for a system to provide an item recommendation, according to an exemplary embodiment.

FIG. 4 is a diagram illustrating a system using the method in FIG. 3 to provide an item recommendation, according to an exemplary embodiment.

FIG. 5 illustrates a block diagram of a system to provide an item recommendation, according to an exemplary embodiment.

FIG. 6 illustrates a block diagram of a system to provide an item recommendation, according to an exemplary embodiment.

### DESCRIPTION OF THE EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of systems and methods consistent with aspects related to the invention as recited in the appended claims.

In exemplary embodiments, there are provided a method and system to generate an item recommendation based on utility for each of a plurality of roles in a business transaction. For convenience of illustration, it is assumed in this disclosure that the plurality of roles are suppliers, consumers, and an intermediary providing a platform for business transactions between the suppliers and the consumers, e.g., an online retailer.

As used herein, the term “item” can be any product, goods, service, inventory, and broadly refers to anything that can be traded, including, e.g., electronic products, automobiles, real estate, rentals, any kind of merchandise, or the like. Examples of services include, but are not limited to, accounting, car repairing, house cleaning, legal, programming, or the like.

As used herein, the term “supplier” can be any party that supplies an item, such as a manufacturer, a retailer, a distributor, a service provider, a rental car company, or the like.

As used herein, the term “consumer” can be any party that purchases or rents an item, such as a person, a company, or the like.

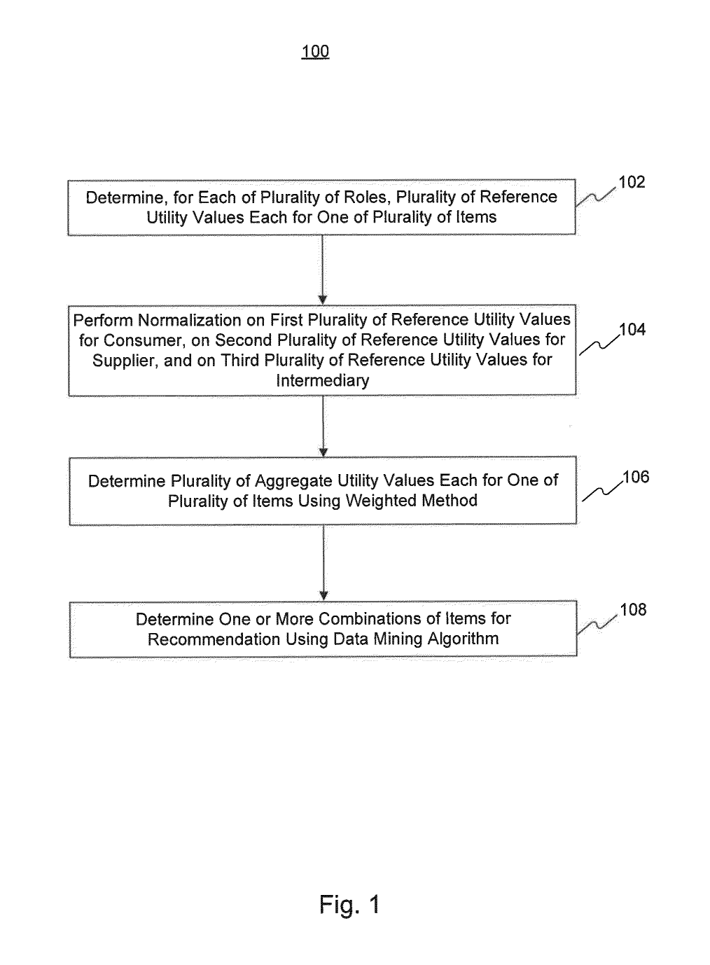

FIG. 1 is a flowchart of a method 100 for a system to provide an item recommendation, according to an exemplary embodiment. Referring to FIG. 1, the system determines, for each of the plurality of roles, a plurality of reference utility values each for one of a plurality of items (102).

In exemplary embodiments, the system determines, e.g., calculates, a first plurality of reference utility values each for one of the plurality of items using one or more consumer utility models. A consumer utility model is a method, usually implemented with an equation, to calculate a utility value of an item with respect to a consumer. In the illustrated embodiment, the system uses the following consumer utility model to calculate the first plurality of reference utility values for a consumer:

Utility_{consumer}(i)=q(i)×(a×e^{b×(-price(i))}) equation (1),

In equation (1), “i” represents an index of item i in the plurality of items; “Utility_{consumer}(i)” represents a calculated reference utility value of item i; “price (i)” represents a price of item i; “q(i)” represents a quantity of item i that has recently been sold in a predefined time period, e.g., one month; “e” represents an exponential function; and “a” and “b” are predetermined values. For example, “a” may be assigned a predetermined value representing a general degree of consumers' caring about prices, and “b” may be assigned a predetermined value representing a general degree of consumers' sensitivity to price changes.

In one exemplary embodiment, the system calculates the first plurality of reference utility values based on one or more consumer utility models, such as a utility model for determining a probability of a need for an item by consumers or a utility model based on an item review. For example, the system determines the probability of the need for the item by consumers by calculating a percentage of a number of the items sold during a preset time period to a number of all items sold during the preset time period, and uses the determined probability as the reference utility value of the item. Also for example, the system determines the reference utility value of the item based on review scores of the item. In one exemplary embodiment, the system calculates a plurality of customer utility values based on each of multiple consumer utility models, and further calculates the first plurality of reference utility values based on the calculated customer utility values, e.g., by performing a weighted summation on the calculated customer utility values.

In exemplary embodiments, the system predetermines the values of a and b based on a review or purchase history of the plurality of items stored in a database of the system. For example, if the review or purchase history indicates that one or more items receive reviews commenting on their high prices, the system predetermines a relatively high value for a. Also for example, if the review or purchase history indicates that one or more items have a significant increase in sales after a price drop, the system predetermines a relatively high value for b. The system may subsequently adjust the values of a and b when the review or purchase history of the plurality of items is updated.

In exemplary embodiments, the system determines, e.g., calculates, a second plurality of reference utility values each for one of the plurality of items using one or more supplier utility models. A supplier utility model is a method, usually implemented with an equation, to calculate a utility value of an item with respect to a supplier. In the illustrated embodiment, the system uses the following supplier utility model to calculate the second plurality of reference utility values for a supplier:

Utilityₛᵤₚₚₗᵢₑᵣ(i)=q(i)×p(i) equation (2).

In equation (2), “i” represents the index of item i of the plurality of items; “Utilityₛᵤₚₚₗᵢₑᵣ(i)” represents the calculated reference utility value for item i; “q(i)” represents the quantity of item i that has recently been sold; and “p(i)” represents a profit for each item i sold.

In one exemplary embodiment, the system calculates the second plurality of reference utility values based on one or more supplier utility models, such as a utility model for determining a profit of an item or a utility model based on a sale status of an item. For example, the system determines the profit of the item by calculating a difference between a sale price of the item and a cost to sell the item, and uses the determined profit as the reference utility value of the item. Also for example, if the item is on sale or clearance, the system sets a high reference utility value for the item. In one exemplary embodiment, the system calculates a plurality of supplier utility values based on each of multiple supplier utility models, and further determines the second plurality of reference utility values based on the calculated supplier utility values, e.g., by performing a weighted summation on the calculated supplier utility values.

In exemplary embodiments, the system determines, e.g., calculates, a third plurality of reference utility values each for one of the plurality of items using an intermediary utility model. An intermediary utility model is a method, usually implemented with an equation, to calculate a utility value of an item with respect to an intermediary. In the illustrated embodiment, the system uses the following intermediary utility model to calculate the third plurality of reference utility values with respect to the web retailer:

Utility_{intermediary}(i)=q(i)×cp(i)×return(i) equation (3).

In equation (3), “i” represents the index of item i of the plurality of items; “Utility_{intermediary}(i)” represents the calculated reference utility value for item i; “q(i)” represents the quantity of item i that has recently been sold; “cp(i)” is a predetermined value representing a general favorite degree of consumers for item i; and “return(i)” represents a commission fee that the intermediary receives for each item i sold.

In one exemplary embodiment, the system calculates the third plurality of reference utility values based on one or more intermediary utility models, such as a utility model based on a commission fee or a utility model based on advertisement income. For example, the system uses a commission fee to an intermediary for selling an item as the reference utility value of the item. Also for example, the system uses the advertisement income for an item as the reference utility value for the item. In one exemplary embodiment, the system calculates a plurality of intermediary utility values based on each of multiple intermediary utility models, and further determines the third plurality of reference utility values based on the calculated intermediary utility values, e.g., by performing a weighted summation on the calculated intermediary utility values.

In exemplary embodiments, the system further performs a normalization on the first plurality of reference utility values for the consumer, on the second plurality of reference utility values for the supplier, and on the third plurality of reference utility values for the intermediary (104), such that the normalized first plurality of reference utility values, the normalized second plurality of reference utility values, and the normalized third plurality of reference utility values are in a same value range, such as from 0 to 1. In one exemplary embodiment, the system performs the normalization using a utility normalization algorithm as follows:

$$Norm ( x ∈ X ) = \{ \begin{matrix}0.5 - 0.5 \times \frac{x - avg ( X )}{min ( X ) - avg ( X )} , & if x \leq avg ( X ) \\ 0.5 + 0.5 \times \frac{x - avg ( X )}{max ( X ) - avg ( X )} & if x > avg ( X )\end{matrix} . \qquad equation ( 4 )$$

In equation (4), “X” represents the first plurality of reference utility values calculated for the consumer, or the second plurality of reference utility values calculated for the supplier, or the third plurality of reference utility values calculated for the intermediary; “x” represents each reference utility value in X; “avg(X)” represents an average value of X; “min(X)” represents a minimum value of X; and “max(X)” represents a maximum value of X. For example, when “X” represents the first plurality of reference utility values calculated for the consumer, “avg(X)” represents an average value of the first plurality of reference utility values; “min(X)” represents a minimum value of the first plurality of reference utility values; and “max(X)” is a maximum value of the first plurality of reference utility values. In the illustrated embodiment, based on equation (4), the system calculates the normalized first plurality of reference utility values for the consumer, the normalized second plurality of reference utility values for the supplier, and the normalized third plurality of reference utility values for the intermediary.

In exemplary embodiments, the system further determines, e.g., calculates, a plurality of aggregate utility values each for one of the plurality of items using a weighted method, based on the first plurality, the second plurality, and the third plurality of reference utility values (106). For example, the system calculates the plurality of aggregate utility values as follows:

Utility_{aggregate}(i)=α×Norm(Utility_{consumer}(i))+β×Norm(Utilityₛᵤₚₚₗᵢₑᵣ(i))+γ>Norm(Utility_{intermediary}(i) equation (5).

In equation (5), “i” represents the index of item i of the plurality of items; “Utility_{aggregate}(i)” represents the calculated aggregate utility value for item i; “Norm(Utility_{consumer}(i))” represents the normalized reference utility value of item i for the consumer and is determined based on equation (4); “Norm(Utilityₛᵤₚₚₗᵢₑᵣ(i))” represents the normalized reference utility value of item i for the supplier and is determined based on equation (4); “Norm(Utility_{intermediary}(i))” represents the normalized reference utility value of item i for the intermediary and is determined based on equation (4); and “α” “β” and “γ” are predetermined weights. For example, the system may assign initial values to “α” “β,” and “γ,” respectively, and dynamically adjust the values when the database of the system is updated.

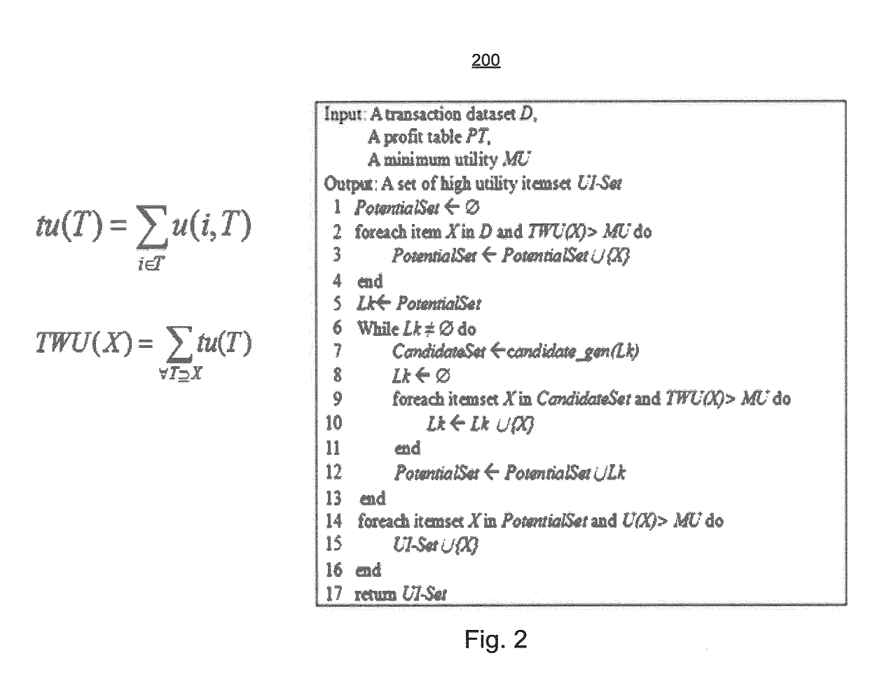

In exemplary embodiments, the system further determines, based on the plurality of aggregate utility values each for one of the plurality of items, one or more combinations of items for recommendation using a data mining algorithm (108), such as a high utility pattern mining algorithm 200 shown in FIG. 2. In FIG. 2, “T” represents a transaction, “u(i, T)” represents a total utility value of all item(s) i in the transaction; “tu(T)” represents a sum of total utility values for all items in the transaction, “TWU(X)” represents estimated utility values for all items, respectively, in a predefined number of transactions, e.g., all transactions, in the database of the system.

For example, it is assumed that the predefined number of transactions are a first transaction T1, a second transaction T2, and a third transaction T3, as follows:

T1: {3 items A, 3 items B, 1 item C};

T2: {1 item D, 2 items E, 2 items C}; and

T3: {2 items A, 3 items D, 2 items C}.

It is also assumed that the aggregate utility values for item A, item B, item C, item D, and item E calculated using equation (5) are as follows:

item A: 10;

item B: 50;

item C: 20;

item D 20; and

item E: 30.

As an example of calculating u(i, T), the total utility value of item A in the first transaction is u(item A, T1)=10×3=30.

As examples of calculating tu(T), the sum of total utility values for all items in the first transaction T1 is tu(T1)=10×3+50×3+20×1=200, and the sum of total utility values for all items in the third transaction T3 is tu(T3)=10×2+20×3+20×2=120.

As an example of calculating TWU(X), the estimated utility value for item A in the predefined transactions is TWU(item A)=tu(T1)+tu(T3)=200+120=320.

Accordingly, based on the high utility pattern mining algorithm 200, the system determines one or more combinations of items for recommendation.

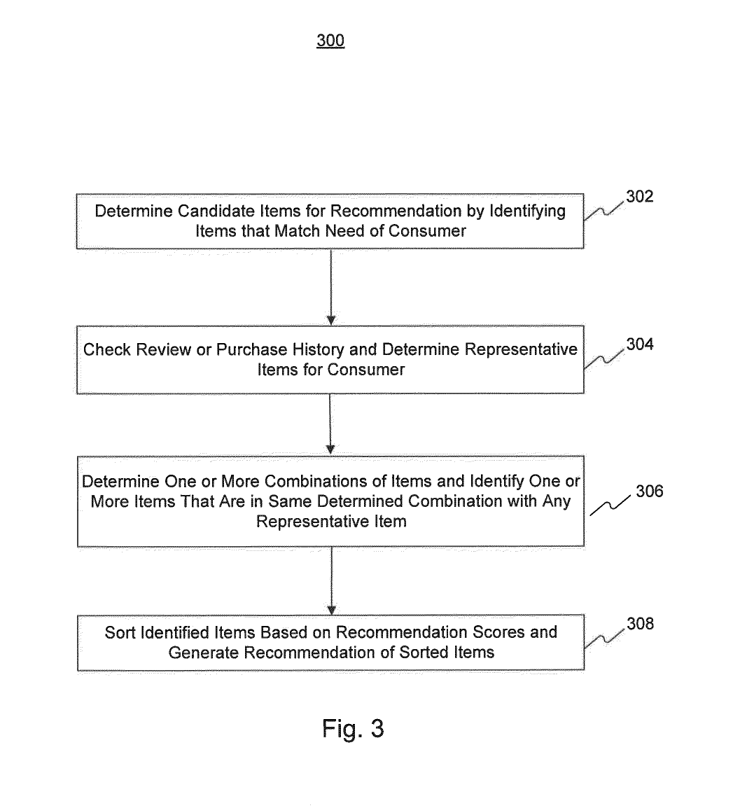

FIG. 3 is a flowchart of a method 300 for a system to provide an item recommendation, according to an exemplary embodiment. Referring to FIG. 3, the system determines candidate items for recommendation by identifying items that match a need of a consumer who is considering purchasing items from the intermediary (302). The system also checks a review or purchase history, e.g., in the consumer's profile, and determines items that are being or have been reviewed or purchased by the consumer as representative items for the consumer (304). The system further determines one or more combinations of items based on aggregate utility values of the candidate items calculated using the method 100 (FIG. 1), and identifies one or more items that are in a same determined combination with any of the representative items (306). The system then sorts the identified items based on recommendation scores and generates a recommendation of the sorted items (308). For example, the system uses aggregate utility values of the identified items, respectively, as their recommendation scores. In one exemplary embodiment, the system does not identify one or more items that are in a same determined combination with any of the representative items because, for example, the consumer is a new consumer. Accordingly, the system identifies all items in the determined one or more combinations, and sorts the identified items based on their aggregate utility values to generate a recommendation.

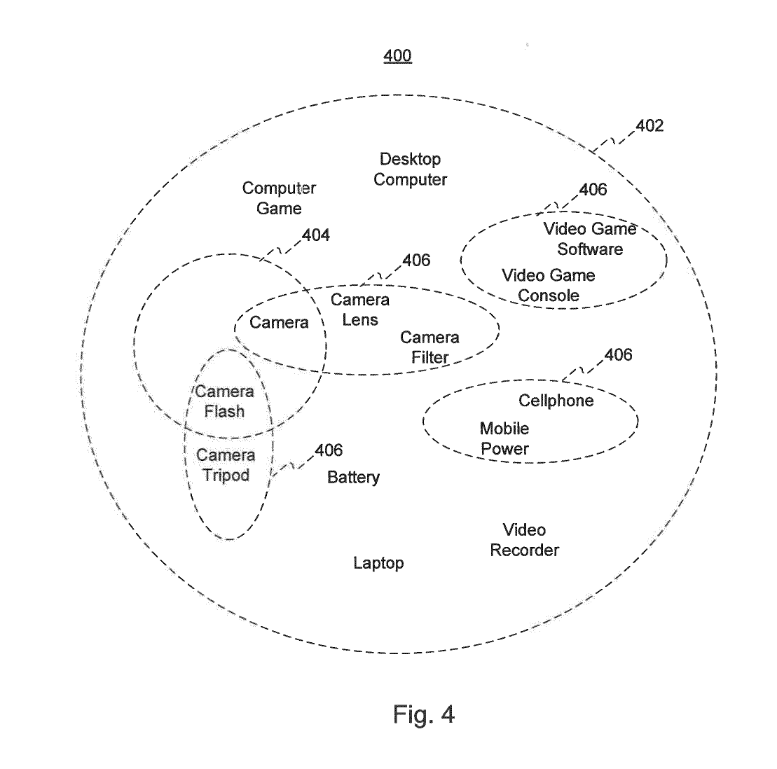

FIG. 4 is a diagram illustrating the system using the recommendation method 300 (FIG. 3) to provide an item recommendation, according to an exemplary embodiment. In the illustrated embodiment, it is assumed that the intermediary is an online retailer, and that a consumer considers purchasing electronic products from the online retailer.

Referring to FIGS. 3 and 4, when the consumer selects, e.g., an “electronic products” tab on a web site of the online retailer, the system determines electronic products available from the online retailer as candidate items 402 to be recommended to the consumer (302). The system also checks a review or purchase history, e.g., in the consumer's profile, and determines items that are being or have been reviewed or purchased by the consumer as representative items 404 (304), such as a camera and a camera flash. The system also determines one or more combinations 406 of items based on aggregate utility values of the candidate items 402, as described above, and identifies one or more items that are in a same determined combination 406 with any of the representative items 404 (306). As a result, in the illustrated embodiment, the system identifies camera lens, camera filter, and camera tripod for recommending to the consumer. The system then sorts the identified items based on recommendation scores and generates a recommendation of the sorted items (308). For example, the system uses aggregate utility values of the identified camera lens, camera filter, and camera, respectively, as their recommendation scores.

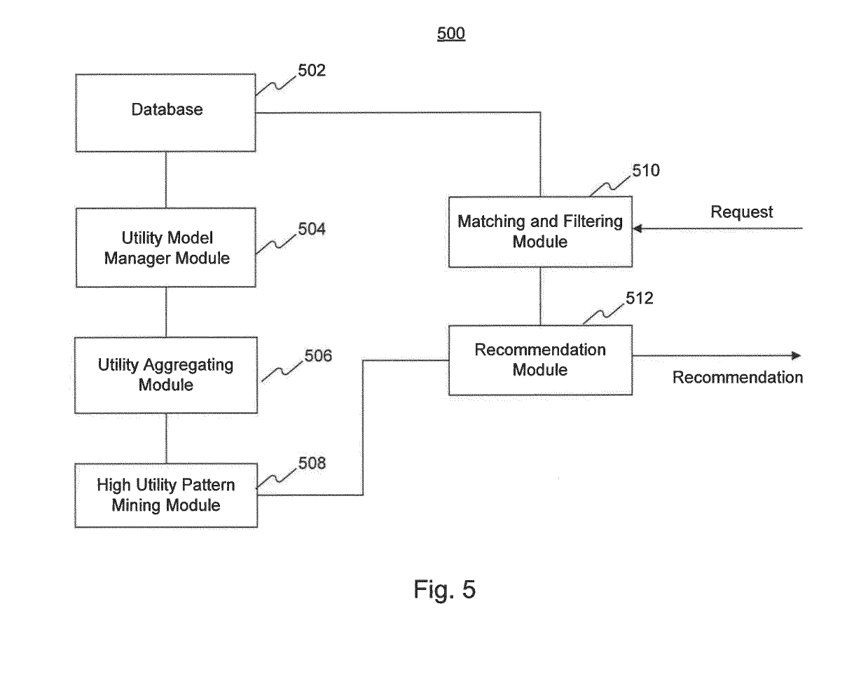

FIG. 5 illustrates a block diagram of a system 500 for providing an item recommendation, according to an exemplary embodiment. Referring to FIG. 5, the system 500 includes a memory for storing a database 502, a utility model manager module 504, a utility aggregating module 506, and a high utility pattern mining module 508. The system 500 additionally includes a matching and filtering module 510 and a recommendation module 512.

In exemplary embodiments, the database 502 stores data for use by the system 500, such as consumers' profiles, a plurality of utility models, and item information including, e.g., a review or purchase record for available items, price and profit information regarding the items, etc.

In exemplary embodiments, the utility model manager module 504 determines, for each of a plurality of roles, a plurality of reference utility values each for one of a plurality of items, as described above in connection with FIG. 1 (102). The utility aggregating module 506 performs a normalization on a first plurality of reference utility values for the consumer, on a second plurality of reference utility values for the supplier, and on a third plurality of reference utility values for the intermediary, and further determines a plurality of aggregate utility values each for one of the plurality of items using a weighted method, as described above in connection with FIG. 1 (104 and 106). The high utility pattern mining module 508 further determines, based on the plurality of aggregate utility values each for one of the plurality of items, one or more combinations of items for recommendation using a data mining algorithm, as described above in connection with FIG. 1 (108).

In exemplary embodiments, the matching and filtering module 510 determines candidate items for recommendation based on a request from a consumer who is considering purchasing items from the online retailer, as described above in connection with FIG. 3 (302). For example, when the consumer selects from a client terminal, such as a computer or a mobile terminal, an “electronic products” tab on a website of the online retailer, the matching and filtering module 510 determines a request from the consumer to review electronic products. The matching and filtering module 510 also checks a review or purchase history, e.g., in the consumer's profile stored in the database 502 and determines items that are being or have been reviewed or purchased by the consumer as representative items for the consumer, as described above in connection with FIG. 3 (304). The recommendation module 512 obtains a result of one or more combinations of items from the candidate items, which is determined by the high utility pattern mining module 508, and identifies one or more items that are in a same combination with any of the representative items, as described above in connection with FIG. 3 (306). The recommendation module 512 then sorts the identified items based on recommendation scores, and generates a recommendation of the sorted items, as described above in connection with FIG. 3 (308).

In one exemplary embodiment, the utility model manager module 504, the utility aggregating module 506, and the high utility pattern mining module 508 operate to determine the one or more combinations of items before the system 500 receives the request from the consumer, and store the determined one or more combinations in the database 502. When the system 500 receives the request from the consumer, the recommendation module 512 checks the database 502 for the determined one or more combinations. In one exemplary embodiment, the utility model manager module 504, the utility aggregating module 506, and the high utility pattern mining module 508 operate to determine the one or more combinations of items when the system 500 receives the request from the consumer.

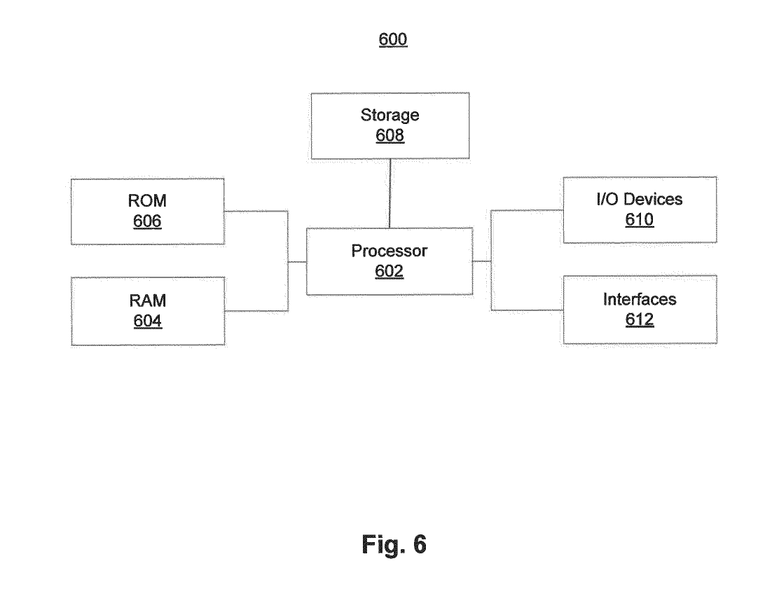

FIG. 6 illustrates a block diagram of a computer-implemented system 600 for performing the above described item recommendation methods, according to an exemplary embodiment. For example, the system 600 may be a server or a personal computer. Referring to FIG. 6, the system 600 may include one or more of the following components: a processor 602 configured to execute program instructions to perform the above recommendation methods, random access memory (RAM) 604 and read-only memory (ROM) 606 configured to access and store information and program instructions, storage 608 to store data and information, such as tables, lists, or other data structures, I/O devices 610, interfaces 612, etc.

In exemplary embodiments, there is also provided a non-transitory storage medium including instructions, executable by the processor 602 in the system 600, for performing the above described recommendation methods.

In one exemplary embodiment, the above described methods and systems are used to provide a job recommendation. In the exemplary embodiment, jobseekers are the consumers, employers are the suppliers, a web site that provides a platform for communications between the job seekers and the employers is the intermediary, and each available job position is an item. In the exemplary embodiment, a reference utility value of an item for a consumer is determined based on a salary of a job position or a distance between the home of a jobseeker and a work location; a reference utility value of an item for a supplier is determined based on a number of jobseekers for a job position or a level of the job position, and a reference utility value of an item for the intermediary is determined based on a commission fee or advertisement income for providing a job position on the web site.

One skilled in the art would understand that multiple models in the exemplary embodiments may be combined into one module, and one model may be divided into multiple models. Each model may be implemented with software, hardware, or a combination of software and hardware.

Other embodiments of the invention will be apparent to those skilled in the art from consideration of the specification and practice of the embodiments disclosed herein. The scope of the invention is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for a system to generate an item recommendation, comprising:
determining, for each of a plurality of roles, a plurality of reference utility values each for one of a plurality of items;
performing a normalization on the plurality of reference utility values determined for each of the plurality of roles;
determining a plurality of aggregate utility values each for one of the plurality of items, based on a plurality of normalized reference utility values determined for each of the plurality of roles; and
determining one or more combinations of items for recommendation based on the plurality of aggregate utility values.

2. The method of claim 1, wherein the determining, for each of a plurality of roles, of a plurality of reference utility values comprises:
determining, for a consumer, a first plurality of reference utility values each for one of the plurality of items based on one or more consumer utility models;
determining, for a supplier, a second plurality of reference utility values each for one of the plurality of items based on one or more supplier utility models; and
determining, for an intermediary, a third plurality of reference utility values each for one of the plurality of items based on one or more intermediary utility models.

3. The method of claim 2, wherein the determining of the first plurality of reference utility values comprises:
determining the first plurality of reference utility values based on at least one of a first utility model for determining a probability of a consumer need for an item or a second utility model based on an item review.

4. The method of claim 2, wherein the determining of the second plurality of reference utility values comprises:
determining the second plurality of reference utility values based on at least one of a first utility model for determining a profit for the supplier or a second utility model based on a sale status of an item.

5. The method of claim 2, wherein the determining of the third plurality of reference utility values comprises:
determining, for an online retailer, the third plurality of reference utility values.

6. The method of claim 5, wherein the determining, for the online retailer, of the third plurality of reference utility values comprises:
determining the third plurality of reference utility values based on at least one of a first utility model based on a commission fee or a second utility model based on advertisement income.

7. The method of claim 1, wherein the determining of the plurality of aggregate utility values comprises:
applying a weighted method to the plurality of reference utility values determined for each of the plurality of roles, to calculate the plurality of aggregate utility values.

8. The method of claim 1, wherein the determining of the one or more combinations of items comprises:
determining the one or more combinations of items using a high utility pattern mining algorithm.

9. The method of claim 1, further comprising:
generating an item recommendation including one or more items in the determined one or more combinations.

10. The method of claim 9, wherein the generating of the item recommendation comprises:
sorting the one or more items.

11. The method of claim 9, wherein the generating of the item recommendation comprises:
determining a plurality of candidate items based on a request from a consumer;
determining a plurality of representative items for the consumer based on information regarding the consumer; and
identifying one or more items from the plurality of candidate items that are in a same determined combination with a first one of the representative items, as the one or more items included in the generated item recommendation.

12. The method of claim 11, wherein the determining of a plurality of representative items comprises:
determining a plurality of items that have been reviewed or purchased by the consumer as the plurality of representative items.

13. A system for generating an item recommendation, comprising:
a processor; and
a memory for storing instructions executable by the processor,
wherein the processor is configured to:
determine, for each of a plurality of roles, a plurality of reference utility values each for one of a plurality of items;
perform a normalization on the plurality of reference utility values determined for each of the plurality of roles;
determine a plurality of aggregate utility values each for one of the plurality of items, based on a plurality of normalized reference utility values determined for each of the plurality of roles; and
determine one or more combinations of items for recommendation based on the plurality of aggregate utility values.

14. The system of claim 13, wherein the processor is further configured to:
determine, for a consumer, a first plurality of reference utility values each for one of the plurality of items based on one or more consumer utility models;
determine, for a supplier, a second plurality of reference utility values each for one of the plurality of items based on one or more supplier utility models; and
determine, for an intermediary, a third plurality of reference utility values each for one of the plurality of items based on one or more intermediary utility models.

15. The system of claim 14, wherein the processor is further configured to:
determine the first plurality of reference utility values based on at least one of a first utility model for determining a probability of a consumer need for an item or a second utility model based on an item review.

16. The system of claim 14, wherein the processor is further configured to:
determine the second plurality of reference utility values based on at least one of a first utility model for determining a profit for the supplier or a second utility model based on a sale status of an item.

17. The system of claim 14, wherein the processor further configured to:
determine, for an online retailer, the third plurality of reference utility values.

18. The system of claim 17, wherein the processor is further configured to:
determine the third plurality of reference utility values based on at least one of a first utility model based on a commission fee or a second utility model based on advertisement income.

19. The system of claim 13, wherein the processor is further configured to:
apply a weighted method to the plurality of reference utility values determined for each of the plurality of roles, to calculate the plurality of aggregate utility values.

20. The system of claim 13, wherein the processor is further configured to:
determine the one or more combinations of items using a high utility pattern mining algorithm.

21. The system of claim 13, wherein the processor is further configured to:
generate an item recommendation including one or more items in the determined one or more combinations.

22. The system of claim 21, wherein the processor is further configured to:
sort the one or more items before generating the item recommendation.

23. The system of claim 21, wherein the processor is further configured to:
determine a plurality of candidate items based on a request from a consumer;
determine a plurality of representative items for the consumer based on information regarding the consumer; and
identify one or more items from the plurality of candidate items that are in a same determined combination with a first one of the representative items, as the one or more items included in the generated item recommendation.

24. The system of claim 23, wherein the processor is further configured to:
determine a plurality of items that have been reviewed or purchased by the consumer as the plurality of representative items.

25. A non-transitory medium including instructions, executable by a processor, for performing an item recommendation method, the method comprising:
determining, for each of a plurality of roles, a plurality of reference utility values each for one of a plurality of items;
performing a normalization on the plurality of reference utility values determined for each of the plurality of roles;
determining a plurality of aggregate utility values each for one of the plurality of items, based on a plurality of normalized reference utility values determined for each of the plurality of roles; and
determining one or more combinations of items for recommendation based on the plurality of aggregate utility values.

26. The non-transitory medium of claim 25, wherein the determining, for each of a plurality of roles, of a plurality of reference utility values comprises:
determining, for a consumer, a first plurality of reference utility values each for one of the plurality of items based on one or more consumer utility models;
determining, for a supplier, a second plurality of reference utility values each for one of the plurality of items based on one or more supplier utility models; and
determining, for an intermediary, a third plurality of reference utility values each for one of the plurality of items based on one or more intermediary utility models.

27. The non-transitory medium of claim 26, wherein the determining of the first plurality of reference utility values comprises:
determining the first plurality of reference utility values based on at least one of a first utility model for determining a probability of a consumer need for an item or a second utility model based on an item review.

28. The non-transitory medium of claim 26, wherein the determining of the second plurality of reference utility values comprises:
determining the second plurality of reference utility values based on at least one of a first utility model for determining a profit for the supplier or a second utility model based on a sale status of an item.

29. The non-transitory medium of claim 26, wherein the determining of the third plurality of reference utility values comprises:
determining, for an online retailer, the third plurality of reference utility values.

30. The non-transitory medium of claim 29, wherein the determining, for the online retailer, of the third plurality of reference utility values comprises:
determining the third plurality of reference utility values based on at least one of a first utility model based on a commission fee or a second utility model based on advertisement income.

31. The non-transitory medium of claim 25, wherein the determining of the plurality of aggregate utility values comprises:
applying a weighted method to the plurality of reference utility values determined for each of the plurality of roles, to calculate the plurality of aggregate utility values.

32. The non-transitory medium of claim 31, wherein the determining of the one or more combinations of items comprises:
determining the one or more combinations of items using a high utility pattern mining algorithm.

33. The non-transitory medium of claim 25, wherein the method further comprises:
generating an item recommendation including one or more items in the determined one or more combinations.

34. The non-transitory medium of claim 33, wherein the generating of the item recommendation comprises:
sorting the one or more items.

35. The non-transitory medium of claim 33, wherein the generating of the item recommendation comprises:
determining a plurality of candidate items based on a request from a consumer;
determining a plurality of representative items for the consumer based on information regarding the consumer; and
identifying one or more items from the plurality of candidate items that are in a same determined combination with a first one of the representative items, as the one or more items included in the generated item recommendation.

36. The non-transitory medium of claim 35, wherein the determining of a plurality of representative items comprises:
determining a plurality of items that have been reviewed or purchased by the consumer as the plurality of representative items.

37. A system to generate an item recommendation, comprising:
a database configured to store a plurality of utility models and consumer information;
a utility model management module configured to determine, for each of a plurality of roles, a plurality of reference utility values each for one of a plurality of items, based on the plurality of utility models;
a utility aggregating module configured to perform a normalization on the plurality of reference utility values determined for each of the plurality of roles, and to determine a plurality of aggregate utility values each for one of the plurality of items, based on a plurality of normalized reference utility values determined for each of the plurality of roles; and
a high utility pattern mining module configured to determine one or more combinations of items for recommendation based on the plurality of aggregate utility values.

38. The system of claim 37, further comprising:
a matching and filtering module configured to determine a plurality of candidate items based on a request from a consumer, and to determine a plurality of representative items for the consumer based on the consumer information stored in the database.

39. The system of claim 38, further comprising:
a recommendation module configured to identify one or more items from the plurality of candidate items that are in a same determined combination with a first one of the representative items, and generate an item recommendation including the one or more items.

40. The system of claim 38, wherein the matching and filtering module receives the request from a client terminal.
